(19) United States
(12) Patent Application Publication
(10) Pub. No.: US 2017/0241066 A1
(43) Pub. Date: Aug. 24, 2017

(54) Laundry appliance that identifies items not intended to be run through a washer or dryer cycle

(71) Applicant: Nicholas Caspers, Bloomington, MN (US)

(72) Inventor: Nicholas Daniel Caspers, Bloomington, MN (US)

(21) Appl. No.: 14/756,921

(22) Filed: Oct. 31, 2015

Related U.S. Application Data
(60) Provisional application No. 62/074,080, filed on Nov. 2, 2014.

(51) Int. Cl. D06F 39/00; G08B 21/24; D06F 37/42; D06F 39/14; D06F 37/04

(52) U.S. Cl. CPC D06F 39/003; D06F 39/005; D06F 39/14; D06F 37/04; D06F 37/42; G08B 21/24; D06F 2202/10; D06F 2204/10; D06F 2216/00

(57) ABSTRACT

Embodiments of the invention relate to the field of laundry appliances. In an embodiment, a laundry appliance system includes a laundry appliance such as a washing machine that includes an opening for receiving and removing clothes and a door that covers the opening during a washing cycle. The washer is equipped with a receiver comprising a computer, an RF reader, and an antenna positioned near the opening. The antenna, for example, may be positioned on or within the door. The antenna may also be a circular pass through antenna tailored to encircle the opening in a way that permits the door to be closed. RFID tags are provided for affixing to items not intended to be laundered (i.e., run through a washing cycle of washing machine or a drying cycle of a dryer appliance). Such items may include wallets, passports, watches, keys, phones, and other electronic devices or important documents that could be damages or destroyed if passed through a washing cycle. When the RF reader detects an RFID tag that has been affixed to an item not intended to be laundered, the receiver alerts the appliance operator by sound, visual information, or other information that an unintended item has been placed in the laundry appliance.

### CROSS-REFERENCE TO RELATED APPLICATIONS

Priority claims are hereby made to U.S. Provisional Application Ser. No. 62/074,080 filed Nov. 2, 2014 entitled “Laundry Appliance that Identifies Items Not Intended To Be Run Through a Washer Or Dryer Cycle” the contents of each of which are incorporated herein by reference.

### TECHNICAL FIELD

Embodiments of the invention relate to the field of laundry appliances, and in particular washer and dryers with advanced technology features.

### BACKGROUND

In the field of laundry appliances, there has been a wide array of advance technology features added over the years. Such features include remote controlled capabilities that allow the operator to control the appliance through a smart phone, noise reduction, speed cleaning, auto-load features that match the water to the load size, automatic temperature control, automatic dispensers for liquid or powder detergent, bleach, and fabric softener, moisture sensors for dryers, and programmable custom cycles.

There remains room for improvement, however, because none of the wide array of advanced technology features that have been added to laundry appliances over the years addresses a problem our mom has complained about for many years, as far back as we can remember. Specifically, my brother and I many times over the years have left our wallets (and other items not intended to be laundered such as phones, watches, identification cards) in pockets of clothes that we throw into the laundry bin. Mom then takes those clothes and runs them through the washer and drying cycles. The result, as shown in the picture at FIG. 13, is that the wallet and its contents are damaged or destroyed. Our invention addresses this problem.

### SUMMARY

To address this problem, we disclose a laundry appliance such as a washing machine with an opening for receiving clothes into a laundry chamber. The laundry appliance includes a receiver that includes an antenna positioned adjacent the opening for detecting an item such as a wallet that is not intended to be laundered (i.e., run through a washing cycle of washing machine or a drying cycle of a dryer). Such items will be referred to herein as unwanted items.

In a preferred embodiment, unwanted items are equipped with an RFID tag. In this embodiment a laundry appliance system comprises a laundry appliance with an opening for receiving clothes within a laundry chamber; a receiver comprising an RF reader that includes an antenna positioned adjacent the opening; an RFID tag for positioning on an item such as a wallet not intended to be laundered; wherein the receiver is configured to alert the appliance operator when the RF reader detects the RFID tag. In this embodiment, the receiver may include a computer, a reader, and an antenna. The reader and antenna may or may not be a combined unit. The computer, reader and antenna may or may not be combined units. The receiver is configured to alert the appliance operator when the unwanted item (which has been equipped with an RFID tag) is detected.

The antenna may be positioned, for example, on or within the appliance's door (e.g., a door that covers the opening during a washing cycle). The antenna may also be a circular pass through antenna tailored to encircle the opening in a way that permits the door to be closed.

Some laundry appliances include doors with translucent or transparent panels that allow a user to view the laundry during a washing cycle. The antenna may be positioned between such panels, and preferably, the antenna is mounted to the surface of the panel that is closer to the chamber when the door is in a closed position.

When the antenna is positioned on or within the appliance door, the system may be configured to detect the unwanted item as it is passed by the door (in the open positioned) as it is being placed in the chamber. We call this “a fly-by” detection, detecting the unwanted item during the time that it is in transit to its destination, in this case, the appliance laundry chamber.

The system may also be configured to detect the unwanted item after it is placed in the chamber and the door is closed. Laundry appliance chambers may include metal components that may inhibit detection of the unwanted item at certain positions within the chamber. To improve the odds that the item is detected, the appliance incorporates a pre-laundering cycle in which the chamber is repositioned so that the item is repositioned within the chamber.

In another embodiment, the receiver's antenna is incorporated into a wall of the laundry chamber to detect unwanted items when they are placed in the chamber. The antenna may, for example, be incorporated into the wall that opposes the door. More than one antenna may be incorporated into the chambers surfaces to improve the odds of detecting unwanted items. If the antenna is positioned behind a panel of the door or behind a wall of the chamber, preferably such panel or wall is formed of non-metallic material.

In another embodiment, the antenna is mounted to or incorporated into a top or side surface of the appliance. In this arrangement, a fly-by detection may be used, such as by placing a laundry basket on top of the appliance that has the antenna incorporated into a top surface of the appliance. If an unwanted item is in the laundry basket, the antenna (and thus the receiver) would detect the unwanted item and alert the user.

Also disclosed is a detector adapted for use with a laundry appliance having an opening for receiving clothes and for wirelessly detecting items not intended to be laundered. The detector comprises a receiver including an RF reader that includes an antenna configured to be positioned adjacent the opening; an RFID tag for positioning on an item not intended to be laundered; wherein the receiver is configured to alert the appliance operator when the RF reader detects the RFID tag.

### BRIEF DESCRIPTION OF THE DRAWINGS

FIG. 1 shows a front view of a washing machine that incorporates our invention. As illustrated, FIG. 1 shows that a wallet (having an RFID tag) has been placed inside the washing machine.

FIG. 2A shows a wallet with an RFID tag and FIG. 2B shows a block diagram of an RFID tag.

FIG. 3 shows a block diagram laundry appliance and laundry system that incorporates our invention.

FIG. 4 shows a perspective view of a washing machine with certain walls being translucent to show part of the inside of the machine.

FIG. 5A shows the washing machine of FIG. 4 that incorporates an embodiment of our invention.

FIG. 5B shows the washing machine of FIG. 4 that incorporates an RF reader. Some of structure that defines opening 12 of the washing machine has been made translucent (or removed) from the drawing to better show positioning of the antenna that surrounds the opening.

FIG. 6 shows the washing machine of FIG. 4 that incorporates another embodiment of our invention.

FIG. 7 shows the washing machine of FIG. 4 that has been retrofitted with a detector that incorporates an embodiment of our invention.

FIG. 8A shows a front view of a washing machine that incorporates our invention.

FIG. 8B shows an exploded perspective view of two glass portions that are used in the door of the washing machine of FIG. 8A.

FIG. 8C shows an exploded perspective view of two glass portions that are used in the door of the washing machine of FIG. 8A, with a combined reader 16 and antenna 17 positioned between the glass portions.

FIG. 9 is a perspective view of a washing machine that incorporates an embodiment of our invention.

FIG. 10 is a perspective view of a washing machine that incorporates an embodiment of our invention.

FIG. 11A is a schematic of a washing machine chamber, and FIG. 11A, FIG. 11B, FIG. 11C, and FIG. 11D illustrate test locations within the chamber.

FIG. 12A is a schematic of a washing machine chamber and defines x, y, and z axes with respect to the chamber.

FIG. 12B shows the x, y, and z axes of FIG. 12A, as well as the xy, xz and yz planes within that three dimension space.

FIG. 13 shows a wallet and contents that were laundered.

FIG. 14 is a simplified, block diagram illustration of how passive RFID tags operate.

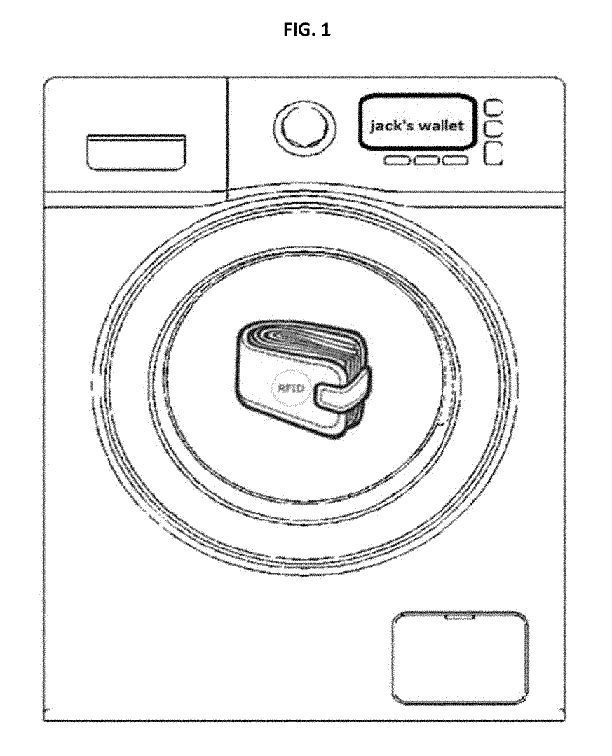

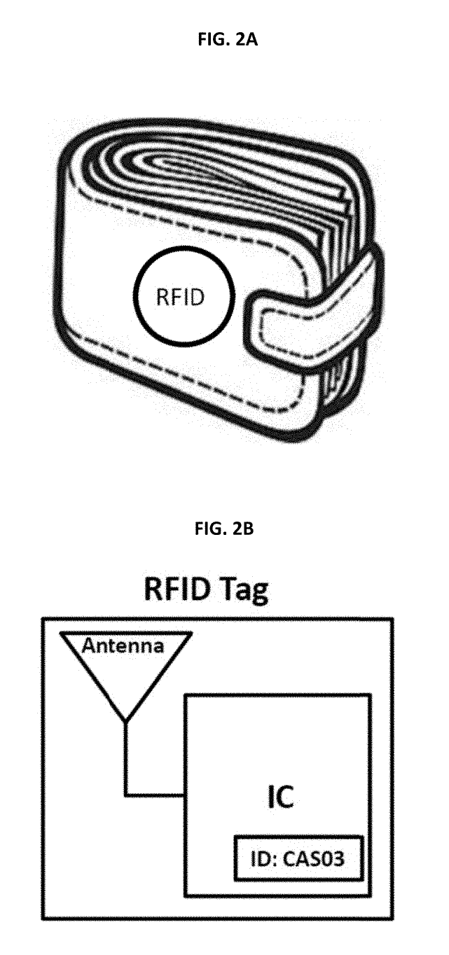

### DETAILED DESCRIPTION

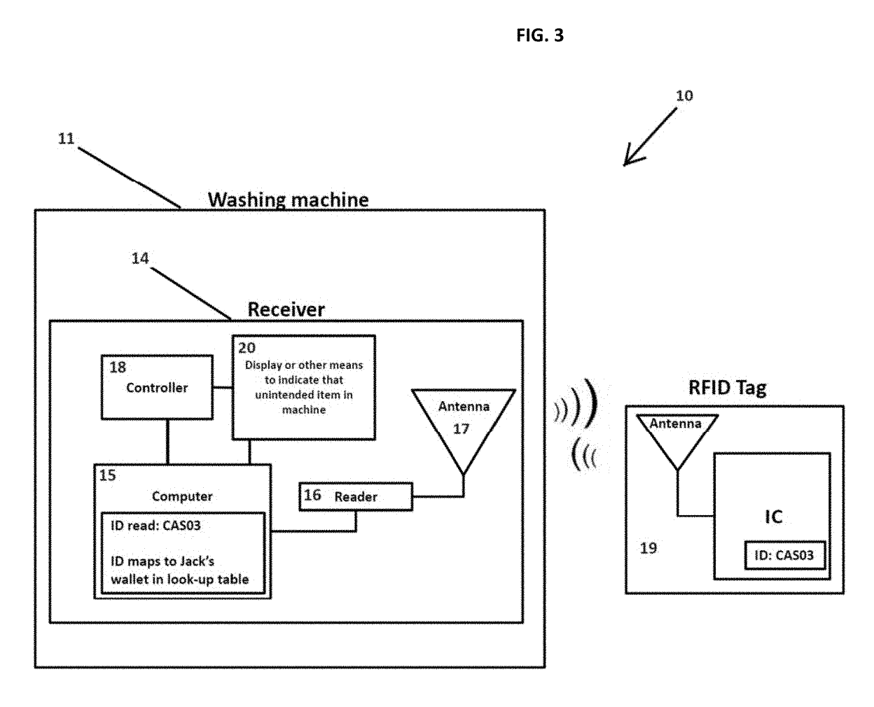

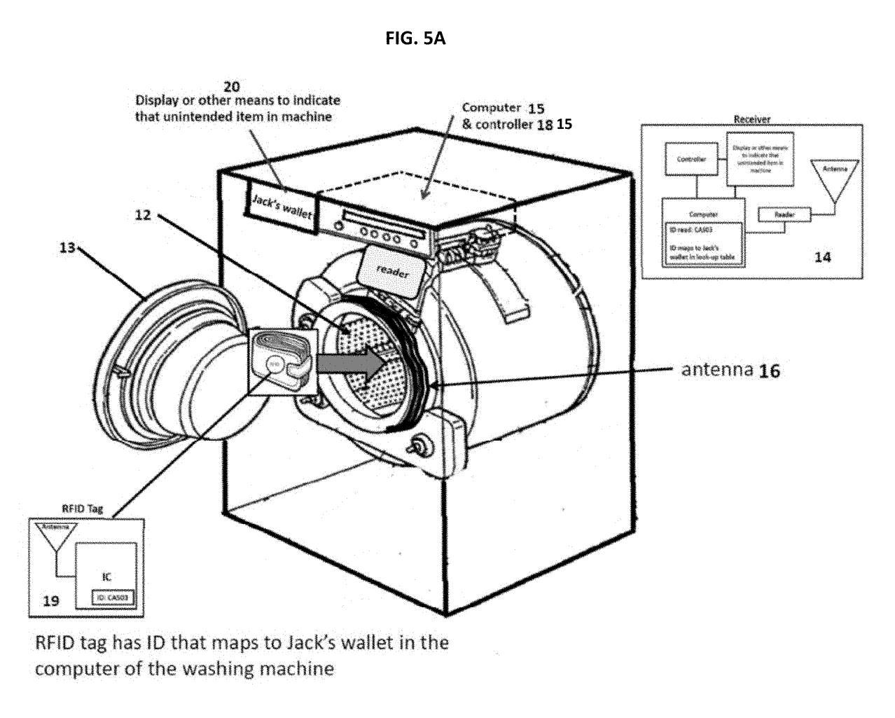

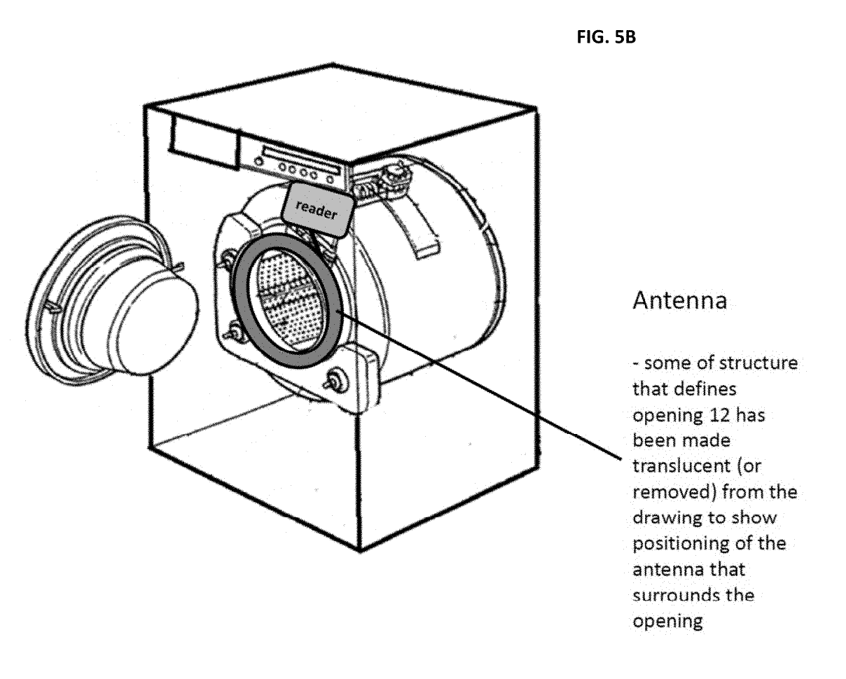

Referring to FIG. 3, FIG. 5A, FIG. 5B, and FIG. 6, an embodiment of laundry appliance system 10 includes a laundry appliance such as a washing machine 11 (washer) that includes an opening 12 for receiving and removing clothes and a door 13 that covers the opening during a washing cycle.

The washer 11 is equipped with a receiver 14 that preferably comprises a computer 15 and an RF reader 16 that includes an antenna 17 positioned adjacent the opening 12 of the washer 11. Computer, as used herein, is broadly defined include a processor or an electronic device designed to accept data, perform prescribed mathematical and logical operations. The computer need not include a display. The antenna 17 may be rectangular or circular, but is preferably tailored to closely encircle the opening in a way that permits the door 13 to be closed. The receiver 14 may also include a controller 18 which may be directed to disable the washing machine 11 or prevent the door 13 from closing when an item that has been tagged with an RFID tag 19 has passed through the opening into the washing machine. The receiver may also include a display 20 for other means (e.g., sound or device for generating audible information) for alerting the machine operator when an item not intended to be laundered (a tagged item) has been placed in the washing machine. The computer 15 may be programmed to match the RFID codes with the names of the items that have been tagged, so that when such items are placed within the laundry, the name will be displayed (e.g. “Jack's Wallet”). This information is useful in assisting the operator in the search for what needs to be removed from the washer before a cycle may start.

RFID tags 19 are provided for affixing to items not intended to be run through a washing cycle. Such items may include wallets, passports, watches, keys, phones, and other electronic devices or important documents that could be damages or destroyed if laundered (i.e., passed through a washing cycle of a washing machine or drying cycle of a dryer appliance). When the RF reader 16 detects an RFID tag 18 that has been affixed to an item not intended to be laundered, the receiver 14 alerts the appliance operator by sound, visual information, or other information that an unintended item has been placed in the washer.

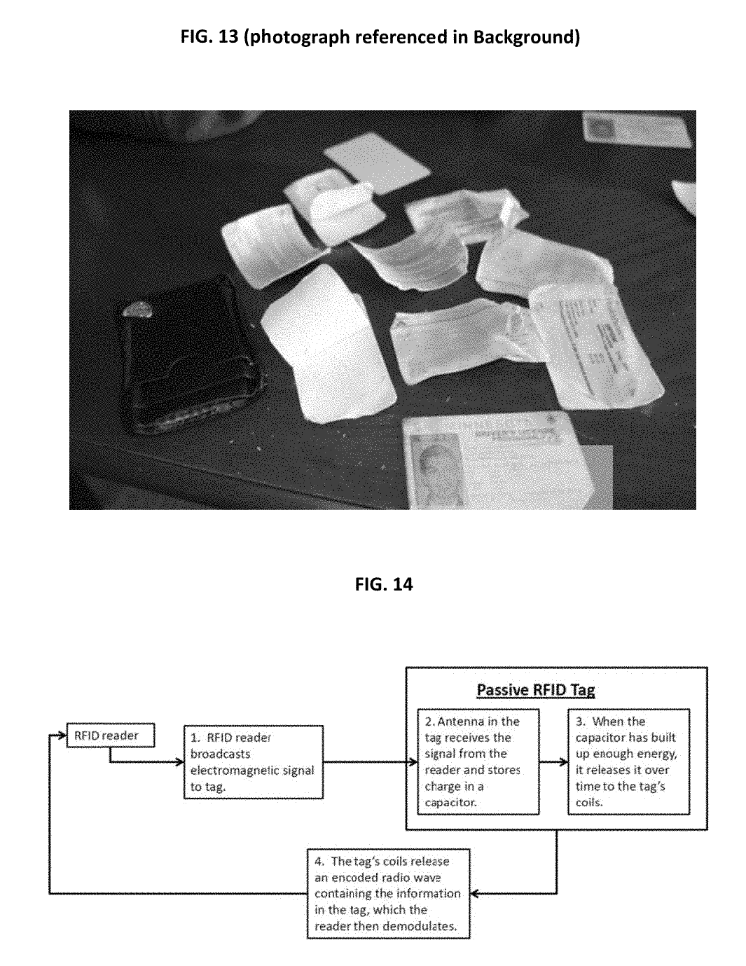

RFID tags are well known. Such tags may be passive, semi-passive (battery assisted), or active, any one of which may be use in the laundry appliance system 10. FIG. 14 is an simplified illustration of how passive RFID tags operate.

A passive tag uses the signal received from the reader to power an IC, and then varies its reflection of that signal to transmit information back to the reader. Passive tags are preferable in cost-sensitive applications. Passive tags have no battery and no transmitter, and thus are inexpensive. Passive tags are range challenged, however.

A semi-passive tag (battery-assisted passive tag), have a battery, like active tags, but still use the reader's power to transmit a message back to the RFD reader using a technique known as backscatter. These tags thus have the read reliability of an active tag but the read range of a passive tag.

An active tag includes radios with theft own transmitting capability independent of the reader, and thus has advantages increased reading range and reliability. The tags also tend to be more reliable because they do not need a continuous radio signal to power their electronics.

Preferably the RFID tag used in system 10 is a passive RFID tag. The passive tags are smaller, cost less, and do not require a battery. Passive tags, however, are less read range range and thus make it more difficult to construct and incorporate an effective antenna for the system 10.

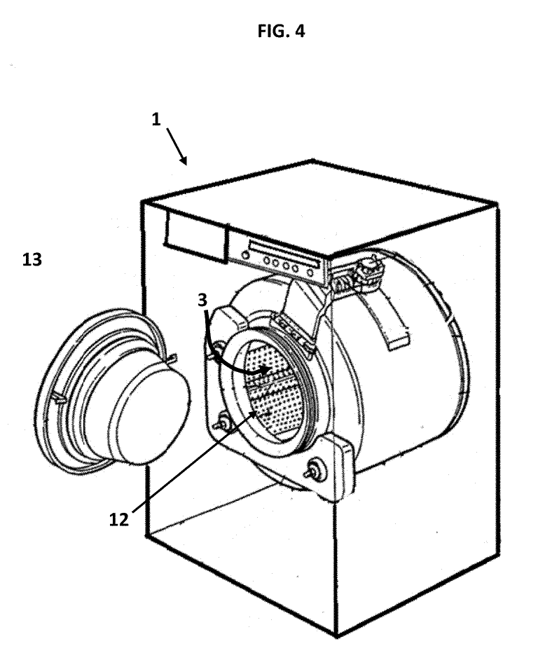

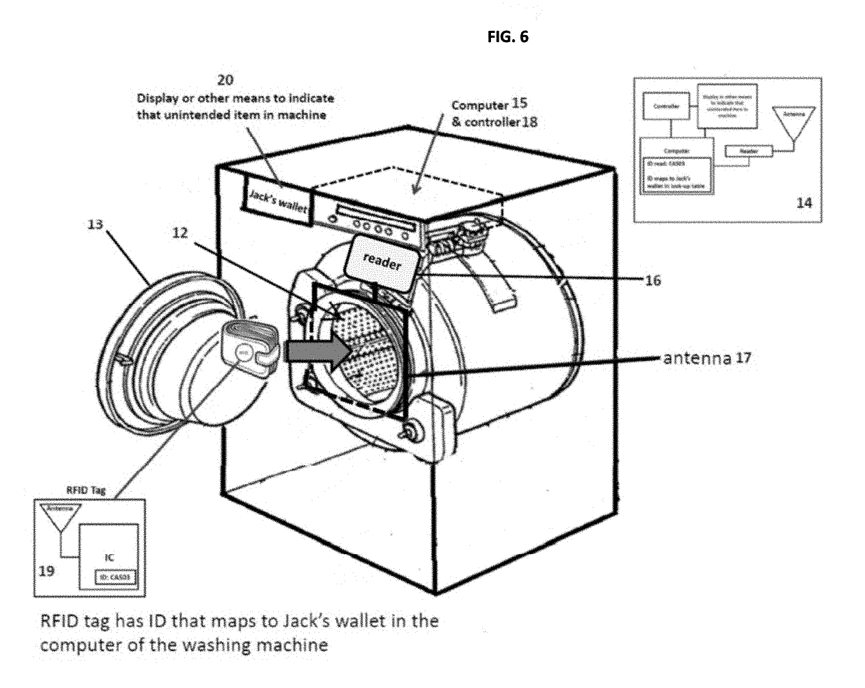

FIG. 7 shows the washing machine of FIG. 4 that has been retrofitted with a detector that incorporates an embodiment of our invention. The detector can be a stand-alone product that is constructed, designed and adapted for use with a laundry appliance, and, once installed, operable to wirelessly detect items not intended to be laundered. The detector comprises a receiver 14 including an RF reader 16 that includes an antenna 17 configured to be positioned adjacent the opening. The antenna 17 may be rectangular or circular, but is preferably tailored to closely encircle the opening in a way that permits the door 13 to be closed. The detector may be provided with (or purchased separately) appropriate RFID tags 19 that the user can position on items not intended to be laundered.

The reader 16 is preferably adapted to be positioned and secured to the washer in close proximity to the antenna 17. The receiver may also include a stand-alone computer and display 20 as shown.

In an alternative embodiment the receiver may be a device that is Bluetooth enabled. Bluetooth devices have the ability to sense other Bluetooth enabled devices. Many of the items not intended to be laundered are already Bluetooth enabled (e.g., phones). The receiver could be adapted to detect such devices when they are put into the laundry and in response alert the user by sound or visual information or by rendering the machine inoperable. One way to render the machine inoperable would be to use a Bluetooth controlled outlet that, in response to a signal from the receiver (e.g., indicating that the RF reader has detected an RFID tag or that a Bluetooth enabled receiver has detected another Bluetooth device in the washing machine), the outlet would be disabled.

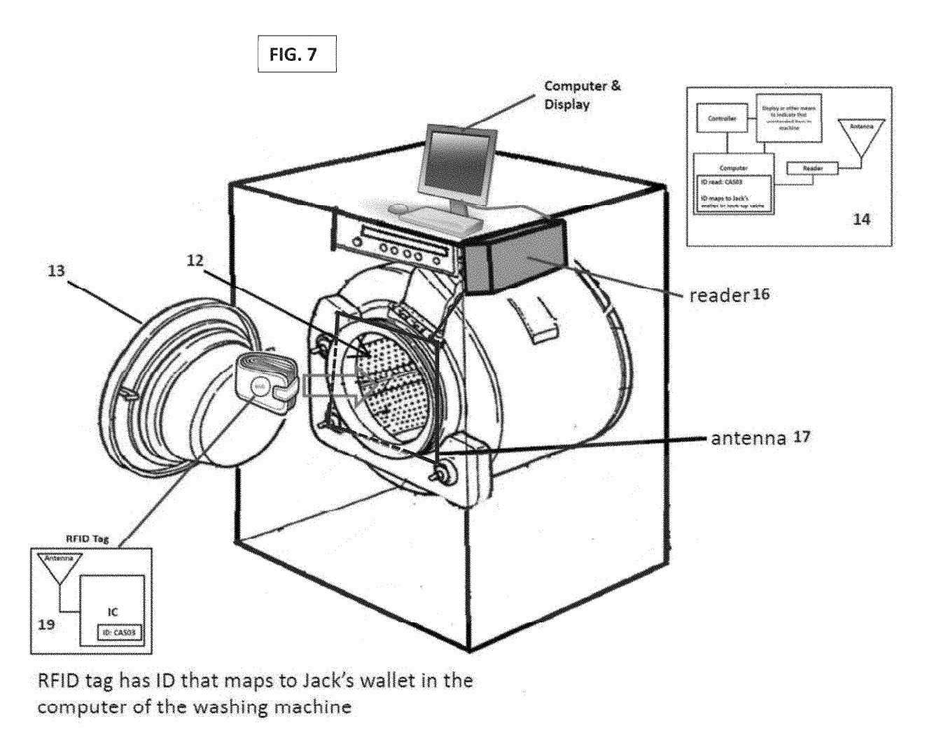

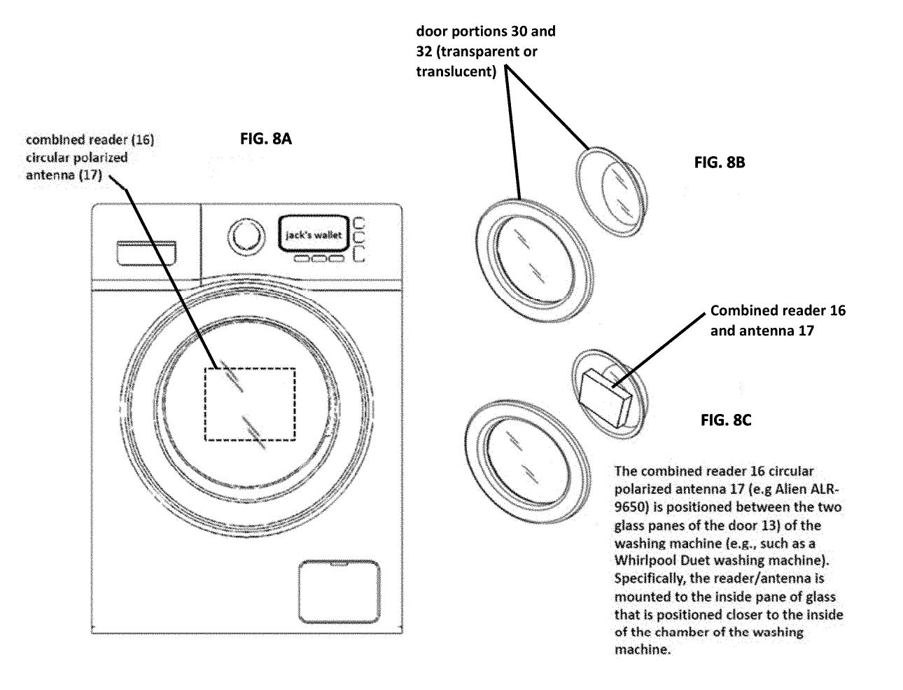

FIG. 8A, FIG. 8B, FIG. 8C, and FIG. 9 illustrate another embodiment of our invention. This embodiment includes a washing machine appliance. The appliance has a door 13 that defines an opening 12 for receiving clothes within a laundry chamber 3 (see FIG. 4). The appliance includes a receiver that includes an antenna positioned to detect unwanted items within the chamber. The receiver will typically include an antenna 17, a reader 16, and a computer 15. In this embodiment the antenna 17 is positioned within the door. The antenna may comprise a separate unit, or, as shown in FIG. 9, the reader and antenna may be combined in a single unit.

The antenna's front face of is positioned adjacent a surface of the door which is preferably formed of non-metallic material so as not to materially inhibit the ability of the antenna to detect unwanted items. As shown in FIG. 8B and FIG. 8C, the door includes an outside portion and an inside portion and the antenna is positioned between the outside and inside portions of the door.

The receiver may include more than one antenna strategically positioned to detect unwanted items within the chamber. It should be understood that the antenna may be positioned adjacent to (or form part of) any surface of the chamber including, for example, a back wall of the chamber that opposes the door and opening.

Some laundry appliances include doors with translucent or transparent panels (FIG. 8A, FIG. 8B, and FIG. 8C) that allow a user to view the laundry during a washing cycle. The antenna may be positioned between such panels, and preferably, the antenna is mounted to the surface of the panel that is closer to the chamber when the door is in a closed position.

When the antenna is positioned on or within the appliance door, the system may be configured to detect the unwanted item as it is passed by the door (in the open positioned) as it is being placed in the chamber. We call this “a fly-by” detection, detecting the unwanted item during the time that it is in transit to its destination, in this case, the appliance laundry chamber.

The system may also be configured to detect the unwanted item after it is placed in the chamber and the door is closed. Laundry appliance chambers may include metal components that may inhibit detection of the unwanted item at certain positions within the chamber. To improve the odds that the item is detected, the appliance incorporates a pre-laundering cycle in which the chamber is repositioned so that the item is repositioned within the chamber.

In another embodiment, the receiver's antenna is incorporated into a wall of the laundry chamber to detect unwanted items when they are placed in the chamber. The antenna may, for example, be incorporated into the wall that opposes the door. More than one antenna may be incorporated into the chambers surfaces to improve the odds of detecting unwanted items. If the antenna is positioned behind a panel of the door or behind a wall of the chamber, preferably such panel or wall is formed of non-metallic material.

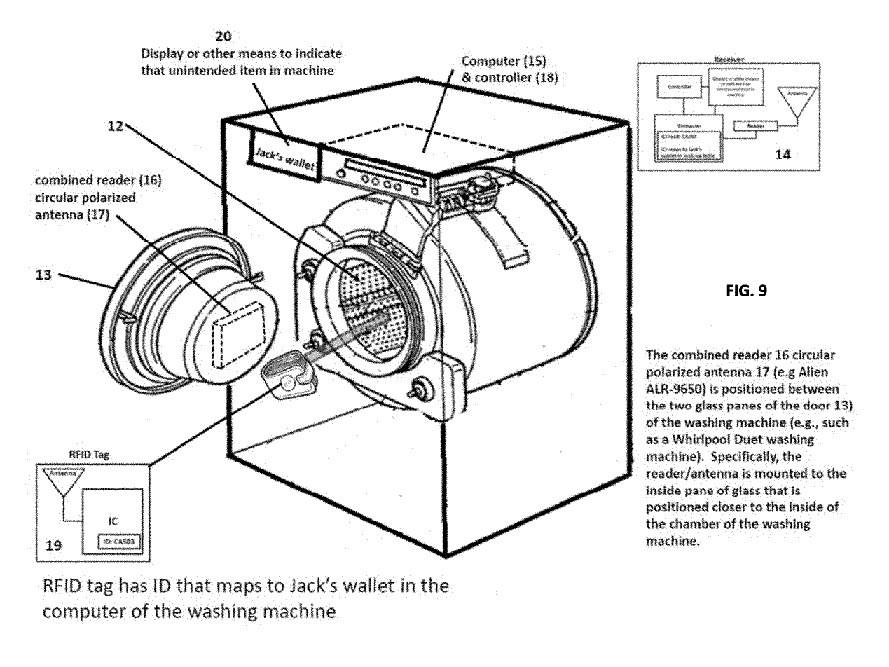

In another embodiment (FIG. 10), the antenna is mounted to or incorporated into a top or side surface of the appliance. In this arrangement, a fly-by detection may be used, such as by placing a laundry basket on top of the appliance that has the antenna incorporated into a top surface of the appliance. If an unwanted item is in the laundry basket, the antenna (and thus the receiver) would detect the unwanted item and alert the user.

### Testing

In developing this invention, we had concerns that, for those embodiments that were dependent on detecting an unwanted item or RFID tag in a laundry appliance chamber, detection would be too inconsistent and thus not work that well. The basis for our concern was that, for those laundry appliances of which we were aware, the laundry chamber was defined by walls that were mostly metal which is an environment not well-suited for RFID equipment. To our surprise, testing showed that an embodiment of our invention that depended on detecting an unwanted item in a laundry appliance chamber worked well.

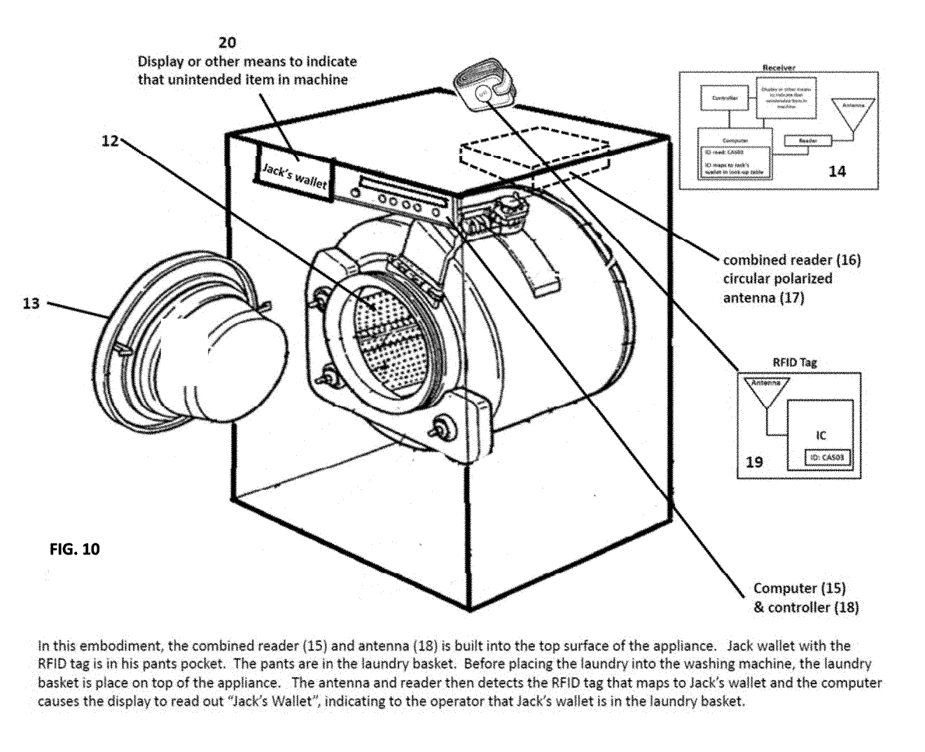

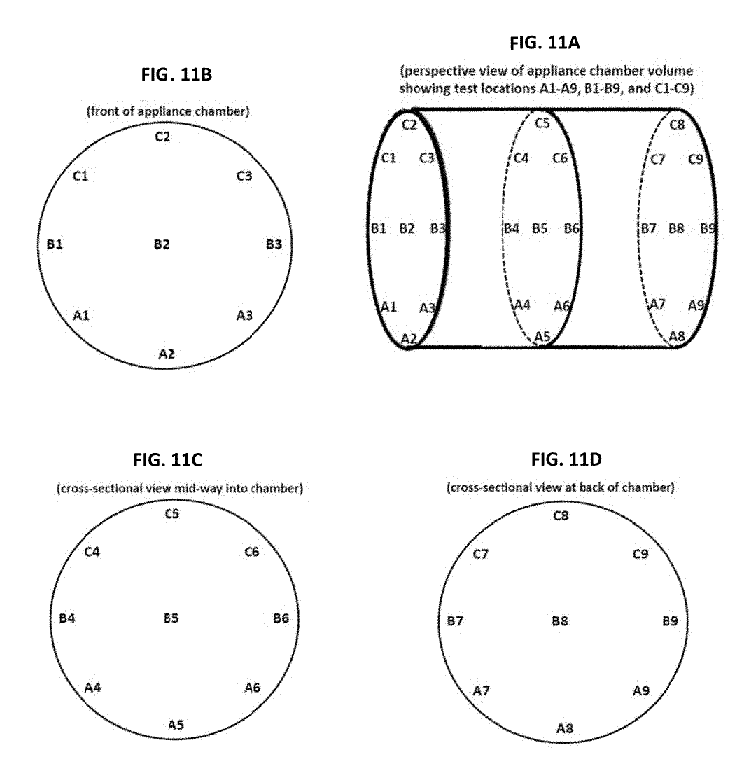

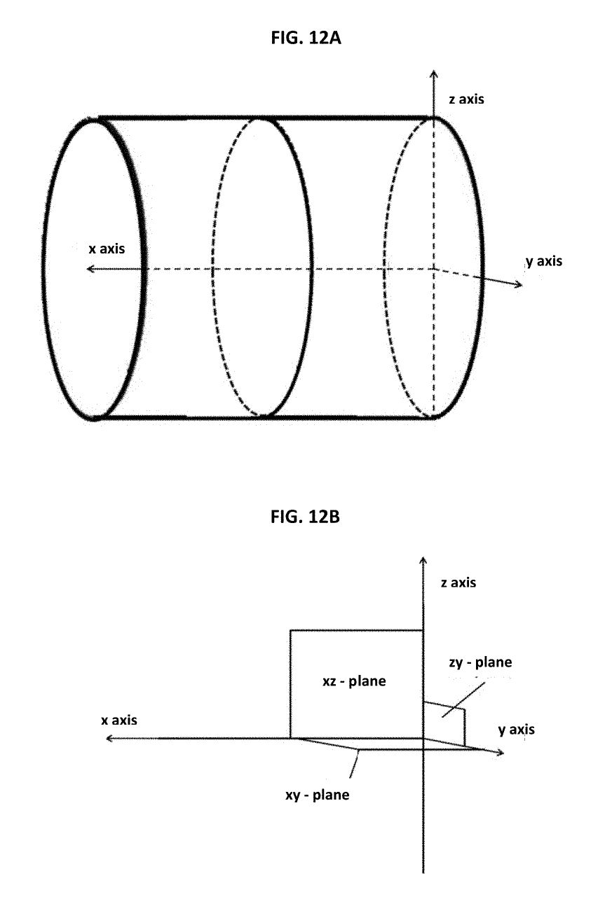

The tested embodiment comprised a Whirlpool Duet front loading washing machine (Whirlpool Duet WFW72HEDW Front-Loading Washer—4.2 cu ft) equipped with an Alien ALR-9650 Integrated RFID Reader which combines reader and circular polarized antenna into a single unit. The combined reader and antenna were positioned within the laundry door as illustrated in FIG. 8A, FIG. 8C, and FIG. 9 (i.e., positioned between two transparent door panels). We tested 11 RFID tags (as identified in Tables 1-11) each of which were affixed to a wallet. FIG. 11A, FIG. 11B, FIG. 11C, and FIG. 11D shows the test locations within the chamber. FIG. 12A is a schematic of a washing machine chamber and defines x, y, and z axes with respect to the chamber, and FIG. 12B shows the xy, xz and yz planes within that three dimension space, defining the three planer orientations for the RFID tag used in the testing. For each of the three planer orientations of FIG. 12A, each tag was tested at each the test locations of FIG. 11A, FIG. 11B, FIG. 11C, and FIG. 11D. The results are shown in Tables 1-11.

The foregoing description of various embodiments of the present invention has been presented for purposes of illustration and description. It is not intended to be exhaustive or to limit the invention to the precise form disclosed. Many modifications and variations are possible. Such modifications and variations that may be apparent to a person skilled in the art of the invention are intended to be included within the scope of the invention as defined by the accompanying claims.

What is claimed is:

1. A laundry appliance comprising:
a washing machine appliance;
the appliance having an opening for receiving clothes; and
a receiver that includes an antenna positioned adjacent the opening for detecting an item not intended to be laundered.

2. The appliance of claim 1 wherein the receiver is configured to alert the appliance operator when the item is detected.

3. The appliance of claim 1 further including a door having an open position to allow laundry to be placed in the chamber and a closed position, wherein the antenna is position on the door to detect an item not intended to be laundered when the item is positioned near the door.

4. The appliance of claim 3 wherein the door comprises an outside portion and an inside portion, wherein the antenna is positioned between the outside and inside portions of the door.

5. The appliance of claim 4 wherein a front face of the antenna faces the inside door portion which is formed of a non-metallic material.

6. The appliance of claim 4 wherein the receiver includes a combined reader and antenna, wherein the combined reader and antenna is positioned between the outside and inside portions of the door.

7. The appliance of claim 1 wherein, to improve odds that the item is detected, the appliance incorporates a pre-laundering cycle in which the chamber is repositioned so that the item is repositioned within the chamber.

8. The appliance of claim 1 wherein the receiver further comprises an RF reader coupled to a computer.

9. The appliance of claim 1 wherein when the item is detected the receiver alerts the appliance operator by an audible sound.

10. The appliance of claim 1 wherein the receiver includes a display and when the item detected the computer alerts the appliance operator by visual information on a display.

11. The appliance of claim 1 wherein when the item is detected the receiver alerts the appliance operator by rendering the appliance temporarily inoperable.

12. The appliance of claim 1 wherein the antenna is a pass through antenna positioned over the opening.

13. The appliance of claim 12 wherein the pass through antenna has a circular shape that is tailored to encircle the opening.

14. The appliance of claim 1 wherein the receiver comprises a Bluetooth device.

15. A laundry appliance system comprising:
a laundry appliance;
the appliance having an opening for receiving clothes;
a receiver comprising an RF reader that includes an antenna positioned adjacent to the opening; and
an RFID tag for positioning on an item not intended to be laundered.

16. The laundry appliance system of claim 15 wherein the receiver is configured to alert the appliance operator when the RF reader detects the RFID tag.

17. The laundry appliance system of claim 5 further including a door having an open position to allow laundry to be placed in the chamber and a closed position, wherein the antenna is position on the door to detect an item not intended to be laundered when the item positioned near the door.

18. The laundry appliance system of claim 17 wherein the door comprises an outside portion and an inside portion, wherein the antenna is positioned between the outside and inside portions of the door.

19. The laundry appliance system of claim 18 wherein a front face of the antenna faces the inside door portion which is formed of a non-metallic material.

20. The laundry appliance system of claim 18 wherein the receiver includes a combined reader and antenna, and wherein the combined reader and antenna is positioned between the outside and inside portions of the door.

21. The laundry appliance system of claim 5 wherein, to improve odds that the item is detected, the appliance incorporates a pre-laundering cycle in which the chamber is repositioned so that the item is repositioned within the chamber.

22. The laundry appliance system of claim 15 wherein the receiver further comprises a computer coupled to an RF reader.

23. The laundry appliance system of claim 15 wherein the antenna is a pass through antenna positioned over the opening.

24. The laundry appliance system of claim 15 wherein the receiver is a Bluetooth device.

25. A detector adapted for use with a laundry appliance having an opening for receiving clothes in a chamber and for wirelessly detecting items not intended for the laundry, the detector comprising:
a receiver comprising an RF reader that includes an antenna configured to be positioned adjacent to the opening;
an RFID tag for positioning on an item not intended to be laundered; and
wherein the receiver is configured to alert the appliance operator when the RF reader detects the RFID tag.

26. The detector of claim 25 wherein the laundry appliance includes a door having an open position to allow laundry to be placed in the chamber and a closed position, and wherein the antenna is adapted to be positioned on a door of the laundry appliance.

27. The detector of claim 26 wherein the door comprises an outside portion and an inside portion, wherein the antenna is adapted to be positioned between the outside and inside portions of the door.

28. The detector of claim 25 wherein the receiver further comprises a computer coupled to an RF reader.

29. The detector of claim 25 wherein the antenna is a pass through antenna positioned over the opening.

30. The detector of claim 29 wherein the pass through antenna has a circular shape that is tailored to encircle the opening.

31. The detector of claim 25 wherein the receiver is a Bluetooth device.

32. A laundry washing appliance comprising:
a receiver that includes an antenna mounted to the appliance to detect an item not intended to be laundered when the item is positioned near the appliance; and
wherein the receiver is configured to alert the appliance operator when the item is detected.

33. The appliance of claim 32 further including a door having an open position to allow laundry to be placed in the chamber and a closed position, wherein the antenna is positioned on the door.

34. The appliance of claim 33 wherein the door comprises an outside portion and an inside portion, wherein the antenna is positioned between the outside and inside portions of the door.

35. The appliance of claim 33 wherein, to improve odds that the item is detected when it is in the chamber, the appliance incorporates a pre-laundering cycle in which the chamber is repositioned so that the item is repositioned within the chamber.

36. The appliance of claim 32 wherein the appliance includes a top surface and wherein the antenna is mounted to the top surface.

37. The appliance of claim 32 wherein the appliance includes a side surface and wherein the antenna is mounted to the side surface.

38. The appliance of claim 32 wherein the receiver further comprises an RF reader coupled to a computer.

39. The appliance of claim 32 wherein the antenna is a pass through antenna positioned over the opening.

40. The appliance of claim 32 wherein the receiver comprises a Bluetooth device.

41. A laundry appliance comprising:
a washing machine having an opening for receiving clothes within a chamber,
a receiver that includes an antenna positioned to detect an item not intended to be laundered that has been passed through the opening and placed within the chamber; and
wherein, to improve odds that the item is detected, the appliance incorporates a pre-laundering cycle in which the chamber is repositioned so that the item is repositioned within the chamber.

42. The appliance of claim 41 wherein the receiver is configured to alert the appliance operator when the item is detected.

43. The appliance of claim 41 further including a door having an open position to allow laundry to be placed in the chamber and a closed position, wherein the antenna is position on the door.

44. The appliance of claim 43 wherein the door comprises an outside portion and an inside portion, wherein the antenna is positioned between the outside and inside portions of the door.

45. A laundry appliance comprising:
a washing machine appliance;
the appliance having a door that defines an opening for receiving clothes within a laundry chamber; and
a receiver that includes an antenna positioned to detect unwanted items within the chamber.

46. The appliance of claim 45 wherein the receiver comprises an antenna, a reader, and a computer.

47. The appliance of claim 45 wherein the antenna is mounted on the door.

48. The appliance of claim 45 wherein the antenna is positioned within the door.

49. The appliance of claim 48 wherein a front face of the antenna is positioned adjacent a surface of the door, wherein the surface comprises a non-metallic material.

50. The appliance of claim 48 wherein the door comprises an outside portion and an inside portion, wherein the antenna is positioned between the outside and inside portions of the door.

51. The appliance of claim 45 wherein the receiver includes at least two antennas positioned to detect unwanted items within the chamber.

52. The appliance of claim 45 wherein the chamber includes a back wall that opposes the opening and the antenna is positioned adjacent to or forms part of the back wall.

53. The appliance of claim 45 wherein at least a portion of the antenna is positioned within the chamber.

54. The appliance of claim 45 wherein the receiver is configured to alert the appliance operator when the item is detected.
